(19) United States
(12) Patent Application Publication
(10) Pub. No.: US 2016/0126601 A1
(43) Pub. Date: May 5, 2016

(54) ATTACHMENT STRUCTURE FOR TEMPERATURE DETECTOR

(71) Applicant: Yazaki Corporation, Tokyo (JP)

(72) Inventors: Yoshiaki ICHIKAWA, Kakegawa-shi (JP); Hirotaka MUKASA, Kakegawa-shi (JP); Hirokuni KOIKE, Kakegawa-shi (JP)

(73) Assignee: Yazaki Corporation, Tokyo (JP)

(21) Appl. No.: 14/926,206

(22) Filed: Oct. 29, 2015

(30) Foreign Application Priority Data
Oct. 30, 2014 (JP) 2014-221876

(51) Int. Cl. H01M 10/48; G01K 13/00; H02J 7/00

(52) U.S. Cl. CPC H01M 10/486; H02J 7/0021; H02J 7/0045; G01K 13/00

(57) ABSTRACT

An attachment structure for a temperature detector, includes a battery module including a plurality of battery cells each having a pair of electrode terminals, an insulating cover configured to be attached to the battery module so as to cover the electrode terminals, a temperature detector configured to contact with a temperature measuring face of the battery cells and detect a temperature of the battery cells, and a temperature detector holding portion formed in the insulating cover. The plurality of battery cells are disposed to stack one another. The temperature detector holding portion hold the temperature detector in a position where the temperature detector contacts with the temperature measuring face when the insulating cover is attached to the battery module.

### CROSS REFERENCE TO RELATED APPLICATIONS

The present invention is based on Japanese Patent Application No. 2014-221876 filed on Oct. 30, 2014, and the contents of which are incorporated herein by reference.

### BACKGROUND OF THE INVENTION

1. Field of the Invention

The present invention relates to an attachment structure for a temperature detector.

2. Description of the Related Art

For example, in a battery or the like of a high-voltage battery pack of an electric car including a hybrid car, a temperature detector (thermistor) such as a temperature sensor or a PTC (Positive Temperature Coefficient) thermistor is attached to a battery connection plate or the like to monitor the temperature of the battery in order to prevent the battery from being overcharged or overdischarged (for example, see JP-A-2008-298662).

In a battery module for an electric car or a hybrid car, a large number of battery cells are connected and arranged side by side to increase an output. Electrode terminals of adjacent ones of the battery cells are connected through a connection member such as a bus bar so that the battery cells can be connected in series or in parallel. To assemble the battery module, electrode terminals must be connected at a plurality of places through connection members. It is therefore necessary to carry out a troublesome work in which a work of connecting each connection member between electrode terminals is repeated. To this end, it has been considered to form a battery connection plate in which a plurality of connection members disposed in a mold have been molded integrally within resin by insert molding in accordance with the number of electrode terminals to be connected.

However, in a battery module in which a plurality of battery cells are arranged, the pitch between electrode terminals formed in adjacent ones of the battery cells may be uneven. In such a case, misalignment may occur between each electrode terminal and each connection member of the battery connection plate when the battery connection plate is connected to the electrode terminal. Thus, the efficiency in the connection work of the battery connection plate deteriorates.

To solve the problem, there has been proposed a battery module in which unevenness in pitch between adjacent ones of electrode terminals can be adjusted easily (see JP-A-2011-210710). As shown in FIG. 6, this battery module 511 includes a plurality of connection members 519 and a flexible flat cable 523. Electrode terminals 515 and 517 of adjacent battery cells 513 are electrically connected through the connection members 519. The flexible flat cable 523 includes flat conductors circumferentially surrounded by insulating resin 531 to be thereby formed into a flat shape. The flexible flat cable 523 couples the connection members 519 with one another.

In the battery module 511 configured thus, the connection members 519 electrically connecting the electrode terminals 515 and the electrode terminals 517 with each other respectively are coupled through the flexible flat cable 523. That is, the aforementioned battery connection plate formed by insert molding or the like is dispensable. According to the battery module 511, unevenness in pitch between adjacent ones of electrode terminals in the battery cells 513 can be, if any, absorbed by folded portions 525 formed in the flexible flat cable 523. As a result, unevenness in pitch between the electrode terminals can be adjusted easily.

However, when the battery module 511 shown in FIG. 6 is used, the battery connection plate storing a thermistor for detecting the temperature of the battery is dispensable. It is therefore necessary to prepare a special member for attaching the thermistor separately.

### SUMMARY OF THE INVENTION

The present invention has been developed in consideration of the aforementioned situation. An object of the invention is to provide an attachment structure for a temperature detector that does not need a special member for attaching the temperature detector.

The aforementioned object of the invention can be attained by the following configurations.

(1) An attachment structure for a temperature detector, including: a battery module including a plurality of battery cells each having a pair of electrode terminals, the plurality of battery cells being disposed to stack one another; an insulating cover configured to be attached to the battery module so as to cover the electrode terminals; a temperature detector configured to contact with a temperature measuring face of one of the battery cells and detect a temperature of the battery cell; and a temperature detector holding portion formed in the insulating cover, wherein the temperature detector holding portion holds the temperature detector in a position where the temperature detector contacts with the temperature measuring face when the insulating cover is attached to the battery module.

In the attachment structure for a temperature detector according to the aforementioned configuration (1), the insulating cover covering the electrode terminals includes the temperature detector holding portion for attaching the temperature detector. The insulating cover is attached to the battery module. The temperature detector is, for example, detachably attached to the temperature detector holding portion. When the insulating cover is attached to the battery module, the temperature detector holding portion is formed with such a positional relationship that the temperature detector attached to the temperature detector holding portion can contact with the temperature measuring face. Accordingly, even when the insulating cover to which the temperature detector has been attached is attached to the battery module or even when the temperature detector is attached to the insulating cover that has been attached to the battery module, the temperature detector can be attached in contact with the temperature measuring face of the battery module.

(2) The attachment structure according to the configuration (1), wherein the temperature detector holding portion is disposed so as to be displaced to one side of the insulating cover relatively to an electrode pole receiving portion formed in the insulating cover for receiving the electrode terminals.

In the attachment structure for a temperature detector according to the configuration (2), the temperature detector holding portion is formed in the insulating cover so as to be displaced to the one side of the insulating cover relatively to the electrode pole receiving portion. Since the temperature detector holding portion is formed without interference with the electrode pole receiving portion, the height can be suppressed to be low. Thus, in the insulating cover, temperature measuring performance can be secured while the height from the top of the battery module can be suppressed.

(3) An attachment structure according to the configuration (1) or (2), further including a battery wiring module configured to be assembled with the battery module, wherein the battery wiring module includes: a plurality of linear conductors that are disposed in parallel and at predetermined intervals; a plurality of bus bars that are disposed in parallel along at least one sides of the linear conductors and at predetermined intervals from one another so as to electrically connect adjacent ones of the electrode terminals of the battery cells; and an insulating resin portion that integrally covers outer circumferential portions of the linear conductors and side edge portions of the bus bars adjacent to the linear conductors; and wherein the linear conductors are electrically connected with corresponding ones of the bus bars respectively.

In the attachment structure for a temperature detector according to the configuration (3), the outer circumferential portions of the linear conductors and the side edge portions of the bus bars are integrally covered with the insulating resin portion so as to construct a battery wiring module in which the bus bars connected through the insulating resin portion are disposed integrally along the linear conductors and at predetermined intervals from one another. Accordingly, a battery connection plate for disposing the bus bars in the battery module can be removed without reducing the attachment workability with which the battery wiring module is assembled with the battery module.

According to an attachment structure for a temperature detector according to the invention, a special member for attaching a temperature detector separately can be made dispensable.

The invention has been described briefly. The details of the invention will be made clearer through the following mode for carrying out the invention (hereinafter referred to as “embodiment”) with reference to the accompanying drawings.

### BRIEF DESCRIPTION OF THE DRAWINGS

FIG. 1 is a main portion sectional view showing an attachment structure for a temperature detector according to an embodiment of the invention.

FIG. 2 is an exploded perspective view of a battery pack provided with the attachment structure for a temperature detector shown in FIG. 1.

FIG. 3 is a main portion exploded perspective view of the battery pack shown in FIG. 2.

FIGS. 4A and 4B are plan views of a battery wiring module.

FIG. 5 is a main portion outline perspective view of an insulating cover in which a temperature detector holding portion is formed.

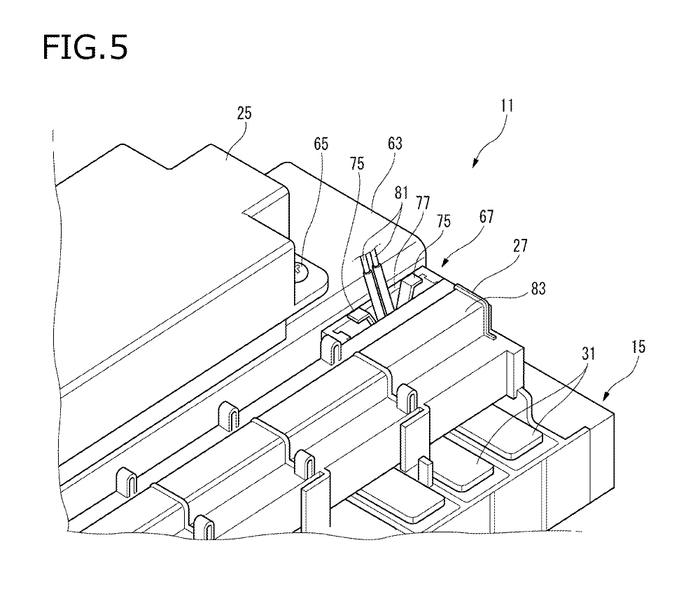

FIG. 6 is a perspective view of a battery module in the background art.

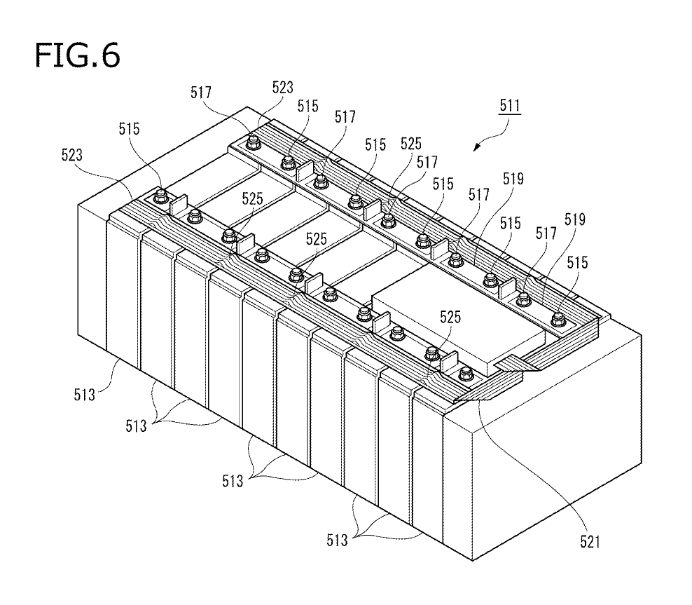

### DETAILED DESCRIPTION OF THE EXEMPLARY EMBODIMENTS

An embodiment of the invention will be described below with reference to the drawings.

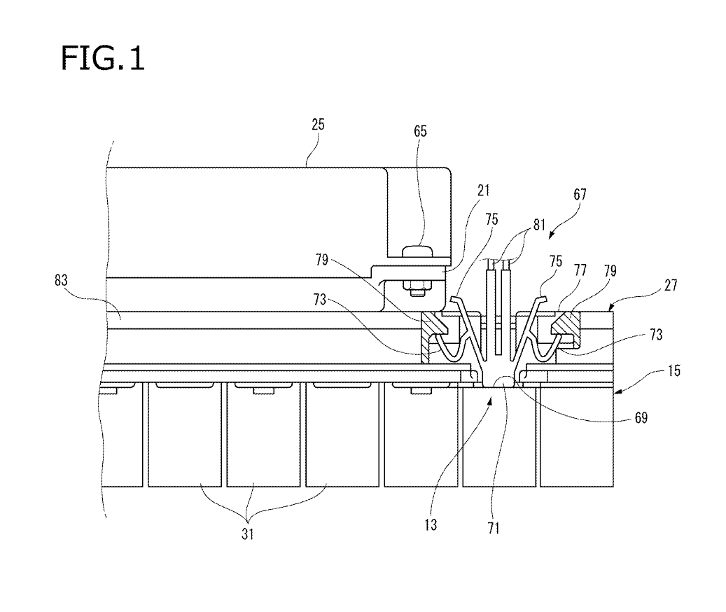

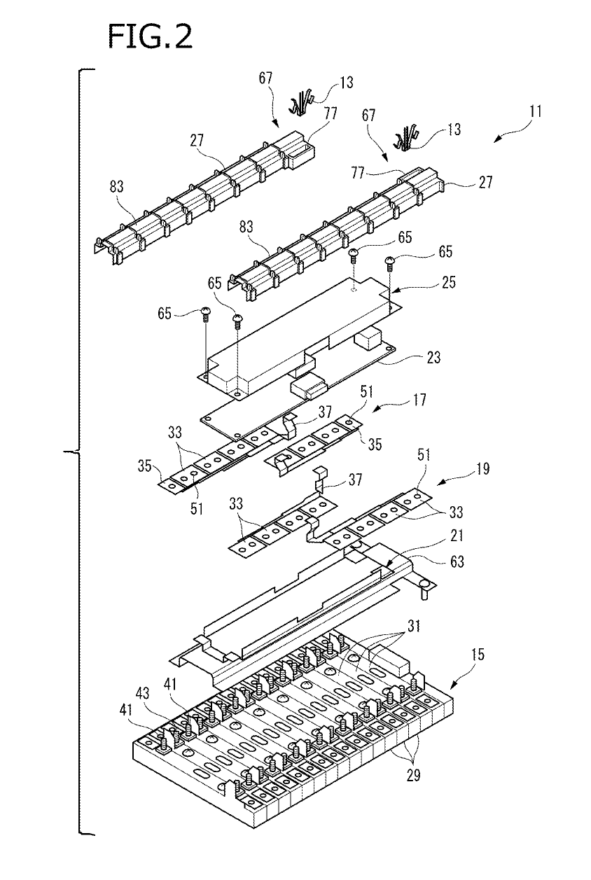

As shown in FIG. 1 and FIG. 2, an attachment structure for a temperature detector according to the embodiment of the invention is used in a battery pack 11 serving as a driving source for an electric car, a hybrid car or the like. Due to the attachment structure for a temperature detector according to the embodiment, a thermistor 13 serving as a temperature detector (temperature sensing element) can be attached to the battery pack 11.

The battery pack 11 includes a battery module 15, a battery wiring module 17, a battery wiring module 19, a unit case 21, a monitoring unit 23, a unit cover 25 and insulating covers 27 as shown in FIG. 2.

In the battery module 15, a plurality of battery cells 31 are disposed and fixed into a not-shown box-like housing through separators 29.

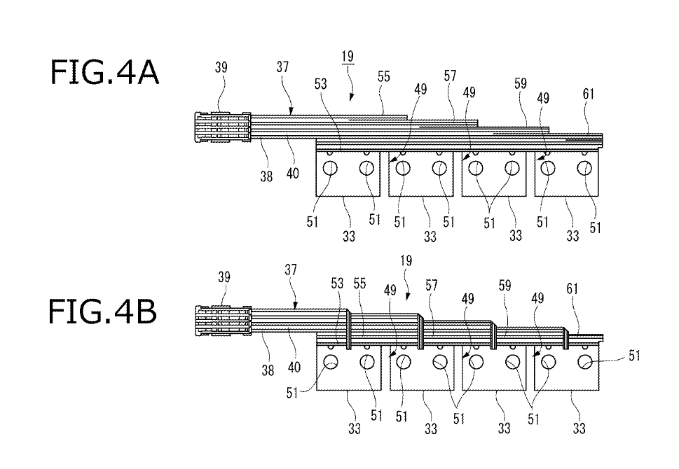

Each of the battery wiring module 17 and the battery wiring module 19 includes a plurality of bus bars 33 and bus bars 35 (see FIG. 2) for connecting the battery cells 31 in series, a voltage detection line 37 for measuring a voltage of each battery cell 31, and a connector 39 (see FIGS. 4A and 4B) connected and fixed to one terminal of the voltage detecting line 37.

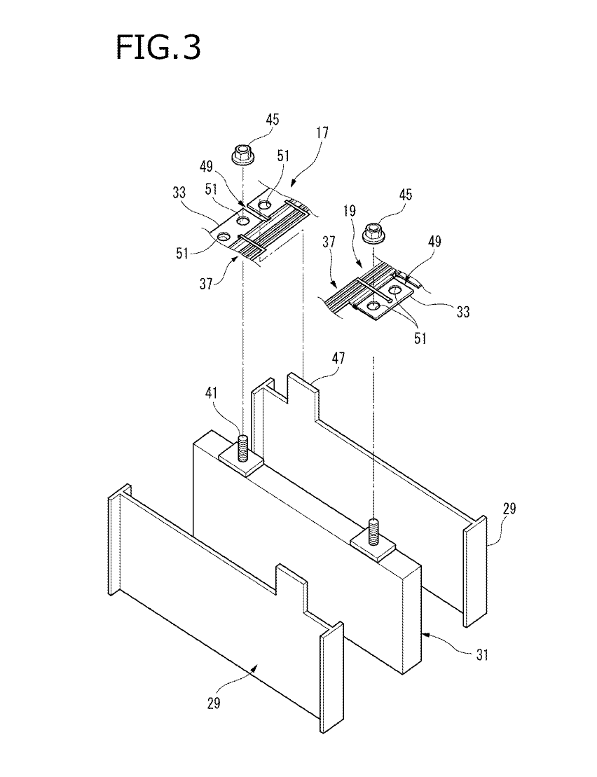

Each battery cell 31 is a secondary battery. As shown in FIG. 3, a positive terminal 41 and a negative terminal 43 serving as a pair of electrode terminals protrude over the top of the battery cell 31. When the battery cells 31 are disposed in a housing, the battery cells 31 are, for example, disposed to be directed alternately reversely so that the positive terminals 41 and the negative terminals 43 can lie alternately and adjacently to each other, as shown in FIG. 2. The positive terminals 41 and the negative terminals 43 are fastened by nuts 45 with the bus bars 33 and the bus bars 35 therebetween.

The separators 29 made of insulating resin as shown in FIG. 3 are disposed on the opposite sides of each battery cell 31. A partition portion 47 protruding upward from the top of the battery cell 31 is formed at the upper end of each separator 29. The partition portion 47 is disposed in a slit 49 (space) formed between adjacent ones of the bus bars to prevent a tool from short-circuiting between electrode terminals.

The belt-like battery wiring modules 17 and 19 are disposed on the battery cells 31 and along the array of the battery cells 31 as shown in FIG. 2.

The battery wiring module 17 and the battery wiring module 19 are disposed in two rows along the array of the battery cells 31. In the battery wiring module 17 and the battery wiring module 19, a plurality of bus bars 33 and bus bars 35 are disposed in two rows on the positive terminals 41 and the negative terminals 43 arranged alternately along the array of the battery cells 31 respectively, and the voltage detection lines 37 are disposed in parallel inside the bus bar arrays of the bus bars 33 and the bus bars 35.

The bus bars 33 and the bus bars 35 constituting the battery wiring module 17 and the battery wiring module 19 are disposed so that terminal insertion holes 51 for connecting the positive terminals 41 and the negative terminals 43 inserted thereto can be arranged in a row. Of the bus bar rows, the bus bar row in the battery wiring module 17 shown on the far side in FIG. 2 has a layout in which one-hole bus bars 35 each having one terminal insertion hole 51 are disposed on the opposite ends, and two-hole bus bars each having two terminal insertion holes 51 are disposed adjacently between the pair of one-hole bus bars 35. Of the bus bar rows, the bus bar row in the battery wiring module 19 shown on the near side in FIG. 2 has a layout in which two-hole bus bars 33 are disposed adjacently.

Each of the voltage detection lines 37 constituting the battery wiring module 17 and the battery wiring module 19 is a flat cable-like line in which outer circumferential portions of a plurality of linear conductors 38 disposed in parallel and at predetermined intervals are covered with an insulating resin portion (insulating resin such as polypropylene (PP), polyvinyl chloride (PVC), polybutylene terephthalate (PBT) or polyethylene terephthalate (PET)) 40 formed integrally by extrusion molding.

In each of the battery wiring module 17 and the battery wiring module 19, side edge portions 53 (see FIGS. 4A and 4B) adjacent to the linear conductors 38 in the bus bars 33 and the bus bars 35 are covered with the insulating resin portion 40 integrally formed by extrusion molding. Thus, the bus bars in which the side edge portions 53 adjacent to the linear conductors 38 through the insulating resin portion 40 are connected to a corresponding one of the voltage detection lines 37 are disposed integrally along one side edge of the voltage detection line 37 and at predetermined intervals from one another.

Each bus bar 33 in the battery wiring module 17 and the battery wiring module 19 electrically connect a positive terminal 41 and a negative terminal 43 adjacent to each other, and is electrically connected to a corresponding one of the linear conductors 38 of the voltage detection line 37 for measuring the voltage of a battery cell 31. Incidentally, each bus bar 35 in the battery wiring module 17 is electrically connected to a positive terminal 41 or a negative terminal 43 in either end portion, and is also electrically connected to a corresponding one of the linear conductors 38 of the voltage detection line 37 for measuring the voltage of a battery cell 31.

The battery wiring module 19 is, for example, formed so that one-side end portions of a plurality of linear conductors 38, that is, an end portion 55, an end portion 57, an end portion 59 and an end portion 61 protrude to right with length increasing stepwise from the upper side toward the lower side as shown in FIG. 4A. That is, the protruding length of the end portion 61 of the lower linear conductor 38 is the longest, and the protruding length of the end portion 55 of the upper linear conductor 38 is the shortest.

In the battery wiring module 19, as shown in FIG. 4B, the linear conductors 38 covered with the insulating resin portion 40 are separated from one another in the end portion 55, the end portion 57, the terminal 59 and the end portion 61 of the linear conductors 38 while the other end portions are left as they are. After that, remaining parts of the linear conductors 38 are folded on the voltage detection line 37 while the end portion 55, the end portion 57, while the end portion 59 and the end portion 61 are folded at right angles toward corresponding ones of the bus bars 33 respectively, and connected to predetermined ones of the bus bars 33 respectively, for example, by welding.

The battery wiring module 17 and the battery wiring module 19 are put on the top of the battery module 15 in which the battery cells 31 are arranged side by side so that a positive terminal 41 and a negative terminal 43 having opposite polarities can be disposed between adjacent two of the battery cells 31. The nuts 45 are screwed down to the positive terminals 41 and the negative terminals 43 protruding from the terminal insertion holes 51. Thus, the battery wiring module 17 and the battery wiring module 19 are fastened to the positive terminals 41 and the negative terminals 43.

The unit case 21 is attached to the battery module 15 between the battery wiring module 17 and the battery wiring module 19 put on the battery module 15. Incidentally, a duct member 63 having a sectionally U-shape opened downward is disposed between the battery module 15 and the unit case 21.

The monitoring unit 23 is mounted in the unit case 21. The voltage detection lines 37 of the battery wiring module 17 and the battery wiring module 19 are connected to the monitoring unit 23 through the connectors 39. Thus, voltage information of the bus bars 33 and the bus bars 35 is transmitted to the monitoring unit 23 through the battery wiring module 17 and the battery wiring module 19.

The unit cover 25 is fixed to the unit case 21 by screws 65 together with the monitoring unit 23. That is, the monitoring unit 23 is fixed integrally to the unit case 21 and the unit cover 25 and covered therewith. The unit case 21 and the unit cover 25 receiving the monitoring unit 23 are attached to the battery module 15 through the duct member 63.

The insulating covers 27 cover the battery wiring module 17 and the battery wiring module 19 exposed to left and right with the unit cover 25 therebetween. Each insulating cover 27 is fixed to the battery module 15 by screws or a lock structure consisting of lock claws and lock portions. When the paired insulating covers 27 are attached to the opposite sides of the battery module 15 with the unit cover 25 therebetween, the positive terminals 41 and the negative terminals 43 are covered with the insulating covers 27 as well as the bus bars 33 and the bus bars 35 of the battery wiring module 17 and the battery wiring module 19.

A temperature detector holding portion 67 is formed in each insulating cover 27. The temperature detector holding portion 67 holds a thermistor 13 in a position where the thermistor 13 can contact with a temperature measuring face 69 of a battery cell 31 when the insulating cover 27 is attached to the battery module 15 (in the position of FIG. 1). The thermistor 13 contacts with the temperature measuring face 69 of the battery cell 31 and detects the temperature of the battery cell 31. Such a temperature detection holding portion 67 may be provided correspondingly to any battery cell 31 in the battery module 15. That is, a temperature detector holding portion 67 may be provided at one place, or temperature detector holding portions 67 may be provided correspondingly to all the battery cells 31 or may be provided at a plurality of places corresponding to desired ones of the battery cells 31.

The thermistor 13 has a thermistor body 71, a pair of lock arm portions 73 fixed to the thermistor body 71, and a pair of pressure arm portions 75 branching from the pair of lock arm portions 73 respectively. In the thermistor 13, the pair of lock arm portions 73 are locked in lock portions 79 of thermistor insertion portions 77 formed in the temperature detector holding portion 67. Thus, an insertion distal end face of the thermistor 13 is brought into elastic tight contact with the temperature measuring face 69 of the battery cell 31, for example, the top face thereof.

A worker inserts the thermistor 13 from above the insulating cover 27 toward the thermistor insertion portions 77. When inserting the thermistor 13 halfway, the worker presses the pair of pressure arm portions 75 from above so as to push the thermistor 13 to a position where the insertion distal end face of the thermistor 13 can be brought into tight contact with the top of the battery. When the insertion distal end face of the thermistor 13 is brought into tight contact with the top of the battery, the pair of lock arm portions 73 are elastically returned and deformed to be locked in the pair of lock portions 79 of the temperature detector holding portion 67. Thus, the insertion work of the thermistor 13 is completed. Heat from the top of the battery is transmitted to the thermistor 13 so that the thermistor 13 can detect the temperature of the battery.

A thermistor electric wire 81 is led out from the thermistor 13. The thermistor electric wire 81 is wired along a thermistor wire arrangement path and connected to the monitoring unit 23.

In addition, in the attachment structure for the thermistor 13 according to the embodiment, the temperature detector holding portion 67 is disposed to be displaced to one side (inside the positive terminals 41 and the negative terminals 43 in the illustrated example) relatively to an electrode pole receiving portion 83 formed in the insulating cover 27 for receiving the positive terminals 41 and the negative terminals 43.

Next, the operation of the attachment structure for the temperature detector according to the embodiment configured thus will be described.

In the attachment structure for the thermistor 13 according to the embodiment, the insulating cover 27 covering the positive terminals 41 and the negative terminals 43 is provided with the temperature detector portion 67 to which the thermistor 13 can be attached. The insulating cover 27 is attached to the battery module 15. The thermistor 13 is, for example, detachably attached to the temperature detector holding portion 67. The temperature detector holding portion 67 is formed with a positional relationship in which the thermistor 13 attached thereto can contact with the temperature measuring face 69 when the insulating cover 27 is attached to the battery module 15. Accordingly, the thermistor 13 can be attached in contact with the temperature measuring face 69 of the battery module 15 even when the insulating cover 27 to which the thermistor 13 has been attached is attached to the battery module 15 or even when the thermistor 13 is attached to the insulating cover 27 which has been attached to the battery module 15.

In addition, in the attachment structure for the thermistor 13 according to the embodiment, the temperature detector holding portion 67 is formed in the insulating cover 27 so as to be displaced to one side relatively to the electrode pole receiving portion 83. Since the temperature detector holding portion 67 is formed without interference with the electrode pole receiving portion 83, the height can be suppressed to be low. Thus, in the insulating cover 27, temperature measuring performance can be secured while the height from the top of the battery module 15 can be suppressed.

Further, in the attachment structure for the thermistor 13 according to the embodiment, the outer circumferential portions of the linear conductors 38 and the side edge portions 53 of the bus bars 33 and the bus bars 35 are integrally covered with the insulating resin portion 40 so as to construct the battery wiring module 17 and the battery wiring module 19 in which the bus bars 33 and the bus bars 35 connected through the insulating resin portion 40 are disposed integrally along the linear conductors 38 and at predetermined intervals from one another. Accordingly, a battery connection plate for disposing the bus bars 33 and he bus bars 35 in the battery module 15 can be removed without reducing the attachment workability with which the battery wiring module 17 and the battery wiring module 19 are assembled with the battery module 15.

According to the attachment structure for the thermistor 13 according to the embodiment, a special member for attaching the thermistor separately can be made dispensable.

The features of the aforementioned embodiment of an attachment structure for a temperature detector according to the invention will be summarized and listed briefly below.

[1] An attachment structure for a temperature detector (thermistor 13), including:

a battery module (15) including a plurality of battery cells (31) each having a pair of electrode terminals (a positive terminal 41 and a negative terminal 43), the plurality of battery cells (31) being disposed to stack one another;

an insulating cover (27) configured to be attached to the battery module (15) so as to cover the electrode terminals (positive terminals 41 and negative terminals 43);

a temperature detector (thermistor 13) configured to contact with a temperature measuring face (69) of one of the battery cells (31) and detect a temperature of the battery cell (31); and
a temperature detector holding portion (67) formed in the insulating cover (27),
wherein the temperature detector holding portion (67) holds the temperature detector (thermistor 13) in a position where the temperature detector (thermistor 13) contacts with the temperature measuring face (69) when the insulating cover (27) is attached to the battery module (15).

[2] The attachment structure according to the paragraph [1], wherein the temperature detector holding portion (67) is disposed so as to be displaced to one side of the insulating cover relatively to an electrode pole receiving portion (83) formed in the insulating cover (27) for receiving the electrode terminals (positive terminals 41 and negative terminals 43).

[3] The attachment structure according to the paragraph [1] or [2], further comprising:

a battery wiring module (17, 19) configured to be assembled with the battery module (15),

wherein the battery wiring module (17, 19) includes:
a plurality of linear conductors (38) that are disposed in parallel and at predetermined intervals;
a plurality of bus bars (33, 35) that are disposed in parallel along at least one sides of the linear conductors (38) and at predetermined intervals from one another so as to electrically connect adjacent ones of the electrode terminals (positive terminals 41 and negative terminals 43) of the battery cells (31); and
an insulating resin portion (40) that integrally covers outer circumferential portions of the linear conductors (38) and side edge portions of the bus bars (33, 35) adjacent to the linear conductors (38); and

wherein the linear conductors (38) are electrically connected with corresponding ones of the bus bars (33, 35) respectively.

Incidentally, the invention is not limited to the aforementioned embodiment, but suitable deformations, improvements and so on may be made thereon. In addition, materials, shapes, dimensions, numbers, arrangement places, etc. of constituent elements in the aforementioned embodiment are not limited but may be selected desirably if the invention can be attained.

What is claimed is:

1. An attachment structure for a temperature detector, the attachment structure comprising:
a battery module comprising a plurality of battery cells each having a pair of electrode terminals, the plurality of battery cells being disposed to stack one another;
an insulating cover configured to be attached to the battery module so as to cover the electrode terminals;
a temperature detector configured to contact with a temperature measuring face of the battery cells and detect a temperature of the battery cells; and
a temperature detector holding portion formed in the insulating cover,
wherein the temperature detector holding portion holds the temperature detector in a position where the temperature detector contacts with the temperature measuring face when the insulating cover is attached to the battery module.

2. The attachment structure according to claim 1, wherein the temperature detector holding portion is disposed so as to be displaced to one side of the insulating cover relatively to an electrode pole receiving portion formed in the insulating cover for receiving the electrode terminals.

3. The attachment structure according to claim 1, further comprising:
a battery wiring module configured to be assembled with the battery module,
wherein the battery wiring module comprises:
a plurality of linear conductors that are disposed in parallel and at predetermined intervals;
a plurality of bus bars that are disposed in parallel along at least one sides of the linear conductors and at predetermined intervals from one another so as to electrically connect adjacent ones of the electrode terminals of the battery cells; and
an insulating resin portion that integrally covers outer circumferential portions of the linear conductors and side edge portions of the bus bars adjacent to the linear conductors; and
wherein the linear conductors are electrically connected with corresponding ones of the bus bars respectively.
